(19) United States
(12) Patent Application Publication
(10) Pub. No.: US 2021/0041034 A1
(43) Pub. Date: Feb. 11, 2021

(54) DRAIN VALVE STRUCTURE

(71) Applicants: KUANG-MING KUO, NEW TAIPEI CITY (TW); BRIDGING PARTNERS CORPORATION, TAIPEI CITY (TW)

(72) Inventor: KUANG-MING KUO, NEW TAIPEI CITY (TW)

(21) Appl. No.: 16/787,363

(22) Filed: Feb. 11, 2020

(30) Foreign Application Priority Data
Aug. 8, 2019 (TW) 108210479

(51) Int. Cl. F16K 27/02; E03C 1/122

(52) U.S. Cl. CPC F16K 27/0272; E03C 1/1222

(57) ABSTRACT

A drain valve structure contains: a body and a stop assembly. The body includes: an accommodation holder, a fixing holder, and a connection seat. The accommodation holder has a threaded groove, a through hole, and a threaded section. The fixing holder includes a first coupling segment, a connecting section, a second coupling segment, and a stepped orifice. The connection seat is connected with the second coupling segment and has an extension, a fitting segment, and an opening. The stop assembly includes a first ring, a second ring, and a third ring which are made of non-metal, the first ring is fixed on an inner wall of the threaded groove of the threaded section, the second ring is fitted with an inner wall of the stepped orifice of the fixing holder, and the third ring is fitted with an inner wall of the opening of the connection seat.

### FIELD OF THE INVENTION

The present invention relates to a drain valve structure which is capable of avoiding lead and heavy metal pollution of the body of the drain valve structure.

### BACKGROUND OF THE INVENTION

A conventional faucet and a drain valve are made of lead copper alloy, and after lead contacts with air, a protection film produces because of oxidation. However, water will drops the protection film and an inner wall of the drain valve contacts with the water, thus producing lead poisoning and pollution.

To overcome such a problem, an automatic drain valve structure is disclosed in TW Utility Model No. M444451 and contains: a body in which a large-diameter stepped orifice and a small-diameter stepped orifice are defined, a resilient element fitted on a stop fringe of a small-diameter section of the body, a stopper, and a fitting sleeve, a hollow stop washer fitted on an inner wall of the small-diameter stepped orifice, a guide plate fitted with an inner wall of a groove on the large-diameter stepped orifice, a rubber washer fitted on an opening of the body, a protruded fringe abutting against the guide plate, a holder fixed on the large-diameter stepped orifice and configured to connect with the faucet, and a through orifice defined on an outer wall of the small-diameter stepped orifice. Thereby, when the guide plate guides the water to flow out of a bottom of the body from the faucet via the hollow stop washer, the fitting sleeve and the rubber washer stop the large-diameter stepped orifice and the small-diameter stepped orifice, thus stopping heavy metal substances.

However, the water flows between the rubber washer and the fitting sleeve and contacts with the heavy metal easily.

The present invention has arisen to mitigate and/or obviate the afore-described disadvantages.

### SUMMARY OF THE INVENTION

The primary aspect of the present invention is to provide a drain valve structure which is capable of avoiding lead and heavy metal pollution of the body of the drain valve structure.

To obtain above-mentioned aspects, a drain valve structure provided by the present invention contains: a body and a stop assembly accommodated in the body and configured to separate water from an interior of the body.

The body includes: an accommodation holder, a fixing holder, and a connection seat.

The accommodation holder has a threaded groove formed in an end of the accommodation holder, a through hole passing through a center of the threaded groove, and a threaded section formed on an outer wall of the threaded groove and configured to connect the threaded groove of the accommodation holder with a water supply pipe.

The fixing holder is hollow and includes a first coupling segment, a connecting section, and a second coupling segment. The first coupling segment is configured to connect with the threaded section of the accommodation holder, and the fixing holder includes a stepped orifice formed on an inner wall of the connecting section of the fixing holder.

The connection seat is configured to connect with the second coupling segment of the fixing holder, the connection seat has an extension extending on a first end of the connection seat and corresponding to the second coupling segment, and the connection seat has a fitting segment arranged on a second end of the connection seat and configured to fit with the water supply pipe, the connection seat further has an opening defined in the connection seat and communicating with the stepped orifice and the through hole.

The stop assembly includes a first ring, a second ring, and a third ring which are made of non-metal, the first ring is fixed on an inner wall of the threaded groove of the threaded section, the second ring is fitted with an inner wall of the stepped orifice of the connecting section of the fixing holder, and the third ring is fitted with an inner wall of the opening of the connection seat.

The accommodation holder is removably connected with the first coupling segment of the fixing holder, the second coupling segment of the fixing holder is removably connected with the extension of the connection seat, so that the first, second, third rings stop water contacting with the body.

The body accommodates the first ring, the second ring, the third ring inside the two ends and an intermediate section of the body respectively so that when water flows out of the through hole of the accommodation holder, the water only contacts with the first ring, the second ring, and the third ring. In other words, the water does not contact the body made of metal so as to avoid lead and heavy metal pollution of the body.

### BRIEF DESCRIPTION OF THE DRAWINGS

FIG. 1 is a perspective view showing the assembly of a drain valve structure according to a preferred embodiment of the present invention.

FIG. 2 is a perspective view showing the exploded components of the drain valve structure according to the preferred embodiment of the present invention.

FIG. 3 is a cross sectional view showing the assembly of the drain valve structure according to the preferred embodiment of the present invention.

### DETAILED DESCRIPTION OF THE PREFERRED EMBODIMENTS

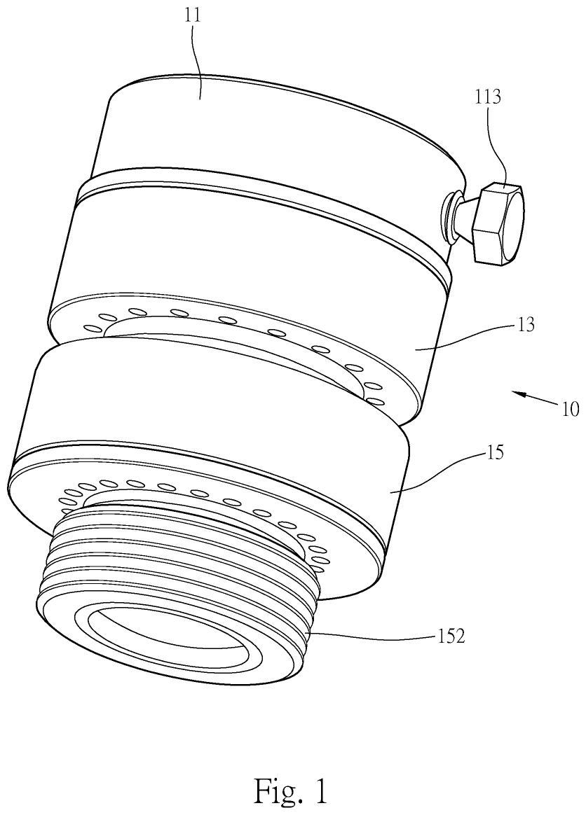

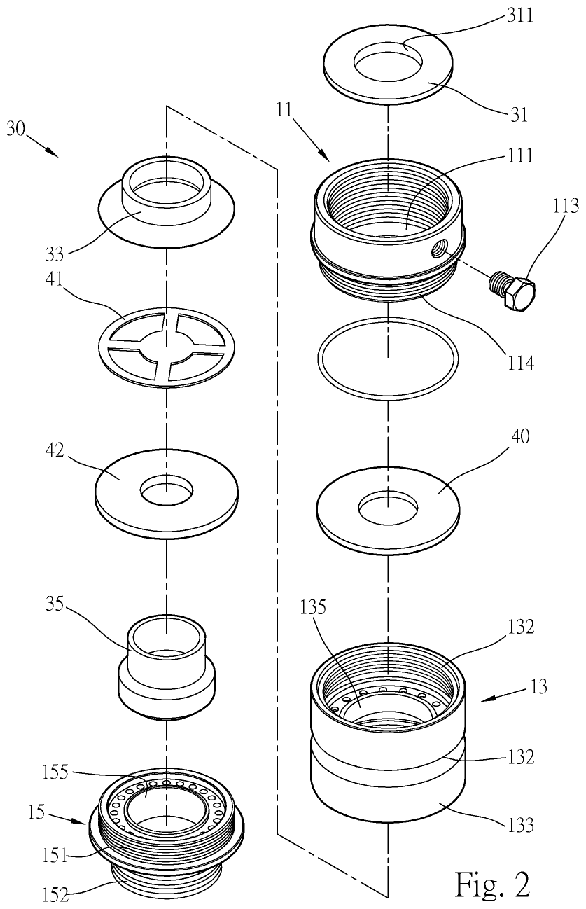

With reference to FIGS. 1 and 2, a drain valve structure according to a preferred embodiment of the present invention comprises a body 10 and a stop assembly 30 accommodated in the body 10 and configured to separate water from an interior of the body 10, thus avoiding lead and heavy metal pollution of the body 10.

The body 10 includes an accommodation holder 11, a fixing holder 13, and a connection seat 15, wherein the accommodation holder 11 has a threaded groove 111 formed in an end thereof, a through hole 112 passing through a center of the threaded groove 111, a locking bolt 113 locked on an outer wall of the threaded groove 111, a threaded section 114 formed on the outer wall of the threaded groove 111 opposite to the locking bolt 113 and configured to connect the threaded groove 111 of the accommodation holder 11 with a water supply pipe (not shown), and the locking bolt 113 is horizontally locked with the water supply pipe.

The fixing holder 13 is hollow and includes a first coupling segment 131, a connecting section 132, a second coupling segment 133, wherein the first coupling segment 131 is hollow and has inner threads configured to screw with the threaded section 114 of the accommodation holder 11, a diameter of the connecting section 132 is less than a diameter of the first coupling segment 131, wherein the second coupling segment 133 is hollow and has inner threads formed on an inner wall of the second coupling segment 133, a diameter of the second coupling segment 133 is equal to a diameter of the first coupling segment 131, and the fixing holder 13 includes a stepped orifice 135 formed on an inner wall of the connecting section 132 of the fixing holder 13.

The connection seat 15 is configured to connect with the second coupling segment 133 of the fixing holder 13, the connection seat 15 has an extension 151 extending on a first end thereof and having outer threads so as to correspond to the second coupling segment 133, and the connection seat 15 has a fitting segment 152 arranged on a second end thereof and configured to fit with the water supply pipe. The connection seat 15 further has an opening 155 defined therein and communicating with the stepped orifice 135 and the through hole 112, wherein a diameter of a middle section of the opening 155 is more than two ends of the opening 155.

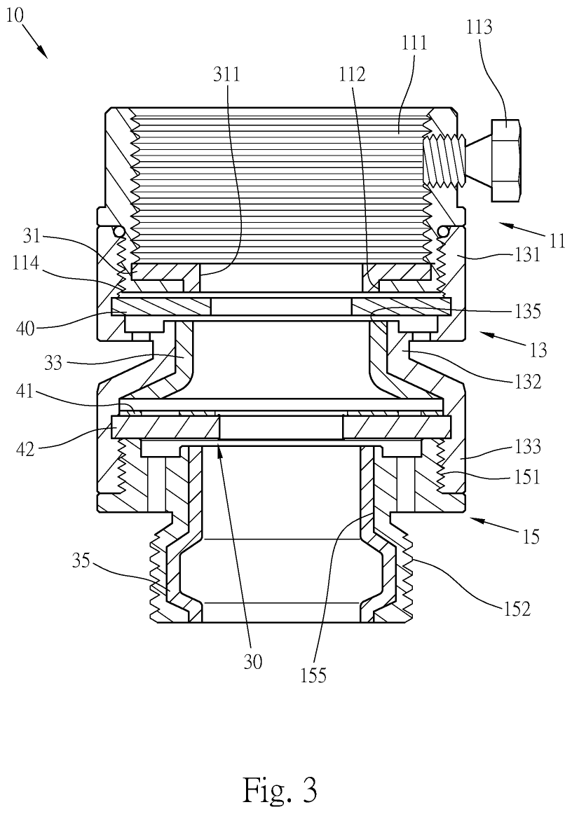

Referring to FIGS. 2 and 3, the stop assembly 30 includes a first ring 31 mating with the accommodation holder 11, a second ring 33 matching with the fixing holder 13, and a third ring 35 mating with the connection seat 15, wherein the first ring 31 is made of rubber and is fixed on an inner wall of the threaded groove 111 of the threaded section 114, a defining fringe 311 extending on an inner wall of the first ring 31 so as to engage with the through hole 112, wherein a height of the defining fringe 311 is equal to a height of the through hole 112 so that the first ring 31 abuts against the inner wall of the threaded groove 111.

The second ring 33 is made of rubber and is fitted with an inner wall of the stepped orifice 135 of the connecting section 132 of the fixing holder 13, wherein a shape of the second ring 33 corresponds to a cross section of the stepped orifice 135 so that the second ring 33 contacts with an inner wall of the stepped orifice 135.

The third ring 35 is made of rubber and is fitted with an inner wall of the opening 155 of the connection seat 15, and a shape of the third ring 35 corresponds to a cross section of the opening 155, such that the second ring 33 abuts against an inner wall of the opening 155.

As shown in FIGS. 2 and 3, a washer 40 is accommodated inside the first coupling segment 131 of the fixing holder 13, the threaded section 114 of the accommodation holder 11 is screwed with the first coupling segment 131 of the fixing holder 13, a positioning disc 41 is disposed on the second coupling segment 133 of the fixing holder 13 on a bottom of the second ring 33 of the connecting section 132, a waterproof element 43 is mounted on the connection seat 15, and the extension 151 of the connection seat 15 is screwed with the second coupling segment 133 of the fixing holder 13 so that the waterproof element 43 is defined between the fixing holder 13 and the connection seat 15, thus connecting the body 10 having the stop assembly 30.

The body 10 accommodates the first ring 31, the second ring 33, the third ring 35 inside the two ends and an intermediate section of the body 10 respectively so that when water flows out of the through hole 112 of the accommodation holder 11, the water only contacts with the first ring 31, the second ring 33, and the third ring 35. In other words, the water does not contact the body 10 made of metal so as to avoid lead and heavy metal pollution of the body 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A drain valve structure comprising: a body and a stop assembly accommodated in the body and configured to separate water from an interior of the body;
wherein the body includes:
an accommodation holder having a threaded groove formed in an end of the accommodation holder, a through hole passing through a center of the threaded groove, and a threaded section formed on an outer wall of the threaded groove and configured to connect the threaded groove of the accommodation holder with a water supply pipe;
a fixing holder being hollow and including a first coupling segment, a connecting section, and a second coupling segment, wherein the first coupling segment is configured to connect with the threaded section of the accommodation holder, and the fixing holder includes a stepped orifice formed on an inner wall of the connecting section of the fixing holder;
a connection seat configured to connect with the second coupling segment of the fixing holder, the connection seat having an extension extending on a first end of the connection seat and corresponding to the second coupling segment, and the connection seat having a fitting segment arranged on a second end of the connection seat and configured to fit with the water supply pipe, the connection seat further having an opening defined in the connection seat and communicating with the stepped orifice and the through hole;
wherein the stop assembly includes a first ring, a second ring, and a third ring which are made of non-metal, the first ring is fixed on an inner wall of the threaded groove of the threaded section, the second ring is fitted with an inner wall of the stepped orifice of the connecting section of the fixing holder, and the third ring is fitted with an inner wall of the opening of the connection seat;
wherein the accommodation holder is removably connected with the first coupling segment of the fixing holder, the second coupling segment of the fixing holder is removably connected with the extension of the connection seat, so that the first, second, third rings stop water contacting with the body.

2. The drain valve structure as claimed in claim 1, wherein a locking bolt is locked on the outer wall of the threaded groove, and the threaded section is formed on the outer wall of the threaded groove opposite to the locking bolt, and the locking bolt is horizontally locked with the water supply pipe, wherein the first coupling segment is hollow and has inner threads configured to screw with the threaded section of the accommodation holder.

3. The drain valve structure as claimed in claim 1, wherein a defining fringe extends on an inner wall of the first ring so as to engage with the through hole, and a height of the defining fringe is equal to a height of the through hole so that the first ring abuts against the inner wall of the threaded groove.

4. The drain valve structure as claimed in claim 1, wherein a diameter of the connecting section of the fixing holder is less than a diameter of the first coupling segment, the second coupling segment is hollow and has inner threads formed on an inner wall of the second coupling segment, and the connection seat has an extension extending on a first end thereof and having outer threads so as to correspond to the second coupling segment, wherein a shape of the second ring corresponds to a cross section of the stepped orifice so that the second ring contacts with an inner wall of the stepped orifice.

5. The drain valve structure as claimed in claim 1, wherein a diameter of a middle section of the opening is more than two ends of the opening, a shape of the third ring corresponds to a cross section of the opening, such that the second ring abuts against an inner wall of the opening.

6. The drain valve structure as claimed in claim 1, wherein a washer is accommodated inside the first coupling segment of the fixing holder, a positioning disc is disposed on the second coupling segment of the fixing holder on a bottom of the second ring of the connecting section, and a waterproof element is mounted on the connection seat, and the extension of the connection seat is screwed with the second coupling segment of the fixing holder so that the waterproof element is defined between the fixing holder and the connection seat.
